(19) United States
(12) Patent Application Publication
(10) Pub. No.: US 2002/0035995 A1
(43) Pub. Date: Mar. 28, 2002

(54) METHOD AND APPARATUS FOR INDUCING ALTERNATING TACTILE STIMULATIONS

(76) Inventors: JURGEN G. SCHMIDT, SAN ANTONIO, TX (US); SHIRLEY JEAN SCHMIDT, SAN ANTONIO, TX (US)

Correspondence Address: STEPHEN H CAGLE, ARNOLD WHITE & DURKEE, P O BOX 4433, HOUSTON, TX, 77210

(21) Appl. No.: 09/375,109

(22) Filed: Aug. 16, 1999

Related U.S. Application Data
(63) Continuation-in-part of application No. 08/943,844, filed on Jul. 22, 1997, now Pat. No. 6,001,073.

(51) Int. Cl. A61H 1/00

(52) U.S. Cl. 128/898

(57) ABSTRACT

An apparatus and method for inducing alternating tactile stimulations in a human subject is disclosed. The device includes a first vibrating element and a second vibrating element connected to a controller. The subject holds the first vibrating element in one hand and the second vibrating element in the other hand. When the device is activated the following occurs in sequence: the first vibrating element vibrates, pauses, the second vibrating element vibrates, pauses, the first vibrating element vibrates, pauses, the second vibrating element vibrates, pauses, and so forth, until the device is deactivated. The first and second vibrating elements are preferably of a hand-held size and shape. The controller has several operating features including: (a) a vibration-duration control which regulates and controls the duration, and thereby intensity, of vibrations (typically 50 to 200 milliseconds), and (b) a pause-duration control which regulates and controls the length of the pause between vibrations (typically 100 to 2000 milliseconds). The controller has a visual display module with: (a) left and right blinking indicators which are synchronized to the activation of the first and second vibrating elements, and (b) a counter display which shows a count of the number of times the first and second vibrating elements have cycled.

### RELATIONSHIP TO PENDING PATENT APPLICATION

This application is a continuation-in-part of commonly owned, co-pending patent application, U.S. Ser. No. 08/943,844 filed Jul. 22, 1997, now U.S. Pat. No. ______.

### BACKGROUND OF THE INVENTION

The invention relates to an apparatus and method for inducing alternating tactile stimulations in a subject, for the treatment of psychiatric and physiologic symptoms. The terms “subject”, and “patient” are used interchangeably in this application. Post-traumatic stress disorder (PTSD) is generally characterized by anxiety attacks, sleep disturbances, flashbacks, and other symptoms which relate to a prior traumatic event. PTSD is particularly common to victims of physical and sexual assault, and to war veterans. Traditional treatments for PTSD, such as “flooding” and “systematic desensitization” have met with limited success.

In 1989 a new psychotherapeutic treatment for post-traumatic stress disorder (PTSD), named Eye Movement Desensitization and Reprocessing (EMDR), was introduced by psychologist Francine Shapiro, Ph.D. In Shapiro's Eight-Phase EMDR protocol, the psychotherapist instructs the patient to recall a picture from the traumatic event, identify related negative thoughts/beliefs, and notice associated body sensations, while an alternating bilateral stimulation is applied. This stimulation can take the form of rapid eye movements, alternating audio stimulation, or alternating tactile stimulation. Before, during and after this procedure the patient is asked for their subjective level of disturbance. It has been found that after EMDR treatment, traumatized patients report significantly reduced levels of PTSD symptoms. Shapiro theorizes that the therapeutic effects of EMDR therapy are connected to the same restorative processes that occur in REM sleep—provided in EMDR therapy by the rapid eye movements, alternating bilateral audio stimulation, and alternating bilateral tactile stimulations. It appears the alternating bilateral stimulation, from these three modalities, somehow accelerates or enhances the brain's information processing capabilities, paving the way for significant reduction of psychological symptoms.

When it was introduced in 1989, EMDR therapy (as described above) was used primarily to treat PTSD. Since that time skilled psychotherapists have developed a variety of EMDR therapy protocols, incorporating the beneficial effects of alternating bilateral stimulation, to treat more than just PTSD. EMDR therapy is now used to treat many more psychiatric and physiologic disorders, such as: clinical depression, anxiety, addictive disorder, eating disorder, obsessive/compulsive disorder., dissociative disorder, sexual dysfunction, panic disorder, learning disabilities, attention deficit disorder, sleep disorder, and pain, to name a few. Furthermore, EMDR psychotherapists are discovering that non-EMDR therapies for psychiatric and physiologic problems are also enhanced by the addition of alternating bilateral stimulations. For example, alternating bilateral stimulations have been found to enhance physical healing, and to be particularly useful in helping patients physically and psychologically prepare for and recover from surgery. In addition, recent unpublished research suggests mechanically-induced alternating bilateral tactile stimulations can be used by patients for self-care to improve the quality of their sleep (when used during the night), reduce levels of pain, reduce symptoms of attention deficit disorder, and reduce anxiety.

### THE PRIOR ART

During EMDR therapy, most patients find it difficult to maintain rapid eye movements without assistance. Therefore, when rapid eye movements are employed, patients are usually asked to track the psychotherapist's hand or fingers moving rapidly back and forth across the patient's field of vision. Some psychotherapists have reported disadvantages to this method, such as difficulty maintaining constant both rate of speed and straightness of path. A device for overcoming this problem was invented by David L. Wilson (U.S. Pat. No. 5,343,261, Aug. 30, 1994). Wilson's device for inducing saccadic eye movements involves a series of evenly-spaced light emitting diodes (LEDs) on a horizontal bar. In use, the LEDs blink on and off in a linear sequence, back and forth across the bar. By tracking the blinking LEDs many patients can easily maintain the rapid eye movements. Wilson's invention also includes a means for generating alternating audio stimulations. While Wilson's invention is useful, it only assists psychotherapists with two of the three EMDR procedure variations, and does not induce alternating tactile stimulations.

Many patients prefer doing EMDR therapy with eyes closed (ruling out eye movements), and some prefer doing EMDR in a quiet environment (ruling out alternating tones). Many patients prefer the tactile stimulation because it helps them feel more grounded. Sometimes intense crying interferes with a patient's ability to maintain rapid eye movements, making an alternative mode necessary. Children often have attention spans too short for doing EMDR with eye movements, necessitating a passive alternative. Patient handicaps, such as blindness or deafness, can also rule out one or more procedure variations. Psychotherapists can manually induce alternating tactile stimulations by tapping on the patient, but there are several disadvantages to doing this:

(a) The psychotherapist has to lean over to physically touch the patient. A full session of bending over may require that the psychotherapist maintain an uncomfortable posture for a prolonged period. (EMDR sessions are typically 1-2 hours long.) Over days, weeks, and months this can lead to chronic discomfort and muscle strain.

(b) Some patients feel threatened when touched. If the psychotherapist manually taps on such a patient he/she risks compromising the therapeutic alliance and ultimately patient progress.

(c) For manual tapping, the patient and the psychotherapist must sit in very close proximity. Some patients feel threatened by such close proximity, which may compromise the therapeutic alliance and ultimately patient progress.

(d) Some patients may construe the psychotherapist's touch as a sexual overture, leaving clinicians vulnerable to complications in the therapeutic process and possibly lawsuits.

(e) The psychotherapist cannot easily take notes during the session if his/her hands are occupied with tapping.

(f) Furthermore, the present invention provides a device and method, which can be easily used by patients for self-care. It allows the patient to experience alternating bilateral tactile stimulation passively, and on demand, so the benefits of this stimulation can be achieved while working, driving, reading, meditating, or sleeping. Without this invention patients would need to stimulate themselves by an activity such as alternate bilateral tapping, walking, or running.

### SUMMARY OF THE INVENTION

The present invention offers a simple and easy way for inducing alternating tactile stimulations in a human subject. In its preferred embodiment the device includes a first vibrating element and a second vibrating element connected to a controller. The subject holds the first vibrating element in one hand and the second vibrating element in the other hand. When the device is activated the following occurs in sequence: the first vibrating element vibrates, pauses, the second vibrating element vibrates, pauses, the first vibrating element vibrates, pauses, the second vibrating element vibrates, pauses, and so forth, until the device is deactivated. The controller has several operating features including: (a) a vibration-duration control which regulates and controls the duration of vibrations (typically 50 to 200 milliseconds), and (b) a pause-duration control which regulates and controls the length of the pause between vibrations (typically 100 to 2000 milliseconds). In its preferred embodiment the controller has a visual display module with: (a) left and right blinking indicators which are synchronized to the activation of the first and second vibrating elements, and (b) a counter display which shows a count of the number of times the first and second vibrating elements have cycled.

One embodiment of this invention is currently marketed by the inventors' company, SchmidtWerks, L.L.C., under the trade name The THERATAPPER™. The THERATAPPER™ has all the invention embodiments listed in this application except the counter and counter display. The THERATAPPER™ has been a commercial success, with hundreds sold to EMDR psychotherapists around the world. Many patients of EMDR psychotherapists have purchased THERATAPPERS™ for self-care, following beneficial experiences in therapy sessions.

An object and advantage of the present invention is to provide a device and method to enable the psychotherapist to administer alternating bilateral tactile stimulations to the patient, which can enhance the information processing capabilities of the brain. This form of brain stimulation, in combination with appropriate EMDR and non-EMDR protocols, is useful for the treatment of many psychiatric and physiologic symptoms. For example, this device and method can be used in the treatment of problems such as: PTSD, clinical depression, addictive disorder, eating disorder, obsessive/compulsive disorder, dissociative disorder, sexual dysfunction, anxiety, panic disorder, learning disabilities, attention deficit disorder, sleep disorder, and pain. It can also be used by a psychotherapist to help the patient to enhance physical healing capabilities, and to enhance the patient's readiness for surgery and recovery from surgery.

Another object and advantage of the present invention is to provide a device and method, which the psychotherapist to can use to induce bilateral alternating tactile stimulation to the patient's body, to maximize comfort and convenience in the therapy session, for both the psychotherapist and patient. Advantages of this device and method are as follows:

(a) The psychotherapist using this device and method can sit in a comfortable and relaxed posture instead of holding, for extended periods, the awkward postures necessary for manually tapping on patients.

(b) With this device and method the psychotherapist can induce alternating tactile stimulations with patients who might otherwise feel threatened by the psychotherapist's touch.

(c) With this device and method the psychotherapist can induce alternating tactile stimulations in the patient at a safe and comfortable distance because the two vibrating elements are attached to the control box by long wires. This is important for patients who might otherwise feel threatened by the psychotherapist's close proximity (as required for manual tapping).

(d) With this device and method the psychotherapist can induce alternating bilateral tactile stimulations in a non-intimate, non-personal way. Therefore, patients will be unlikely to perceive this tactile stimulation as a sexual overture.

(e) The psychotherapist can take notes throughout the session, since his/her hands will not be occupied with tapping on the patient.

(f) The psychotherapist and/or patient can adjust the device's duration and pause controls to suit the individual preferences of the patient.

(g) The first and second vibrating elements are sized and shaped for convenient application to a number of bilateral points on the patient's body. For example, they can be easily held in the hands, slipped under wristbands, inserted into socks or shoes, or placed under thighs. Therefore, placement of the vibrating elements can be easily suited to the individual needs and preferences of the patient.

(h) During operation the device counts and displays the number of induced alternating tactile stimulations, so a psychotherapist using this device can focus entirely on listening to and watching the patient. No additional attention would be needed for counting.

Another object of the present invention is to provide a device and method, which the patient can use as needed, outside the EMDR therapy session, to treat psychiatric and physiologic symptoms. For example, this device and method can be used by the patient for self-care to treat problems such as: anxiety, panic disorder, learning disabilities, attention deficit disorder, sleep disorder, and pain. It can also be used by the patient for self-care to enhance physical healing capabilities, and to enhance readiness for surgery and recovery from surgery.

Another object and advantage of the present invention is to provide a device and method, which can be easily used by patients for self-care. The present invention allows the patient to experience alternating bilateral tactile stimulation passively, and on demand, so the benefits of this stimulation can be achieved while working, driving, reading, meditating, or sleeping. Without this invention patients would need to stimulate themselves by an activity such as alternate bilateral tapping, walking, or running.

### BRIEF DESCRIPTION OF THE DRAWINGS

FIGS. 1A and 1B show a perspective view of one embodiment of the device for inducing alternating tactile stimulations in a human subject.

FIG. 2 is a perspective view of one embodiment of the device of this invention.

FIG. 3 provides a perspective view of one embodiment of the device of this invention, with a cutaway view of the first and second vibrating elements, and a cutaway view of the back of the controller.

FIG. 4 is an electrical block diagram of one embodiment of the device of this invention.

### DESCRIPTION OF ILLUSTRATIVE EMBODIMENTS

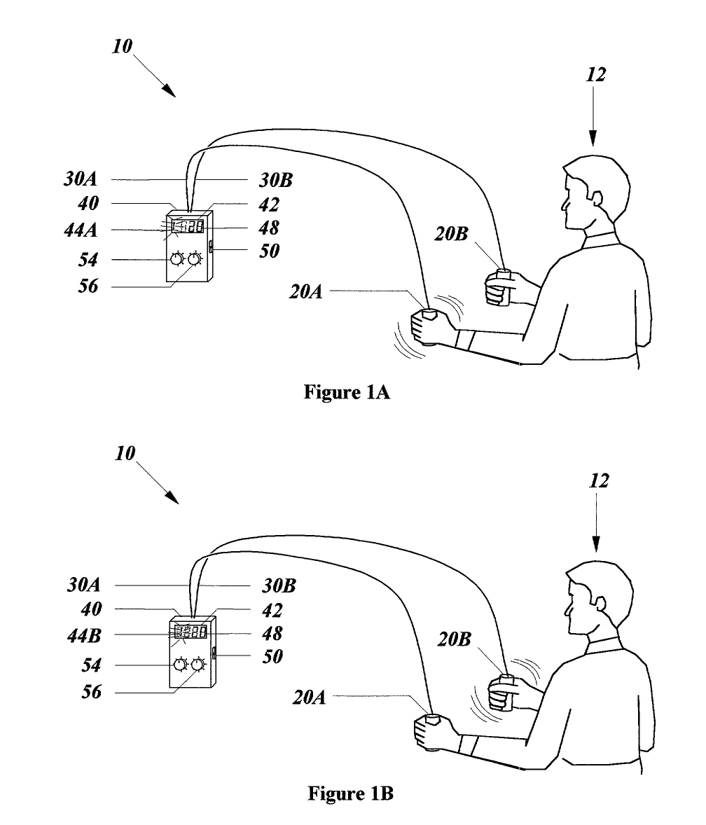

FIG. 1 shows a device 10 inducing alternating tactile stimulations in a subject 12 who is holding a first vibrating element 20A and a second vibrating element 20B. The first vibrating element 20A is connected to a controller 40 by a first electrical connection 30A and the second vibrating element 20B is connected to the controller 40 by a second electrical connection 30B. The controller 40 houses a power switch 50, a vibration-duration control 54, a pause-duration control 56, and a visual display module 42. The visual display module 42 has two important features:

(a) it has a left blinking indicator 44A and a right blinking indicator 44B which are synchronized with the activation of the first and second vibrating elements 20A and 20B respectively; and

(b) it has a digital counter display 48 which displays the number of times the first and second vibrating elements 20A and 20B have been activated since switching on the power.

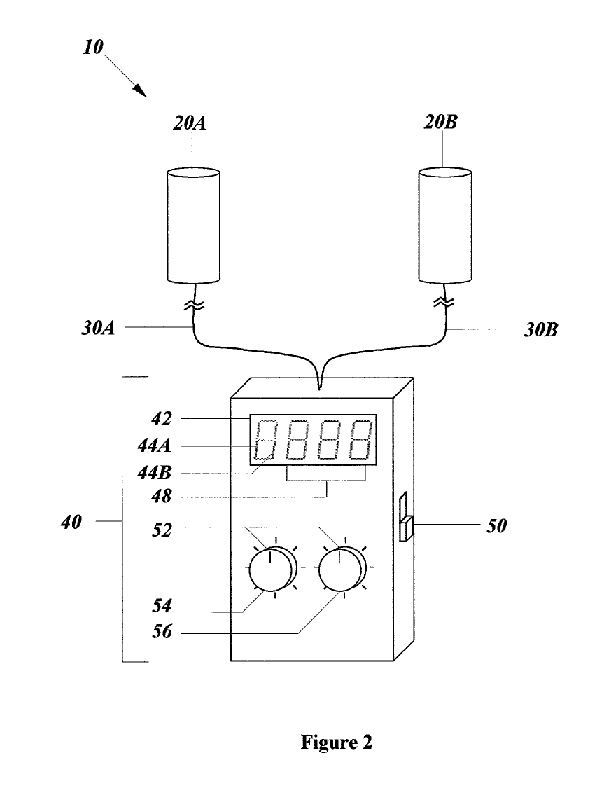

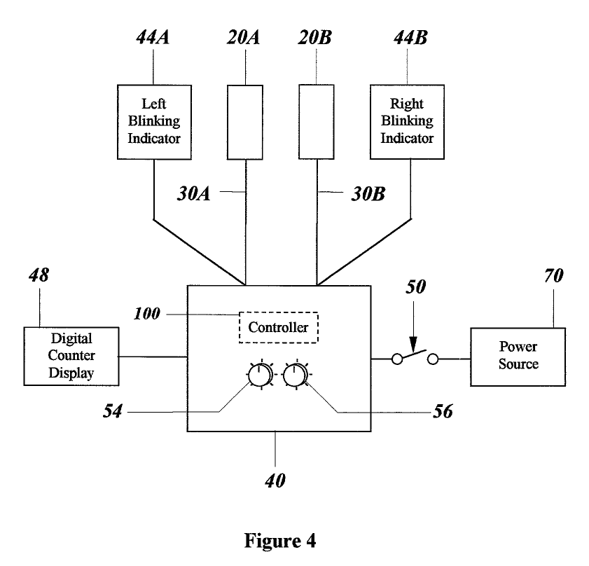

FIG. 2 shows a close-up perspective view of the device 10. The first and second vibrating elements 20A and 20B are connected to the controller 40 by the first and second electrical connections 30A and 30B. The controller 40 houses the power switch 50, operating controls 52, and the visual display module 42. The visual display module 42 may consist of four 7-segment numeric light emitting diode (LED) digits. Three of these digits comprise the digital counter display 48. Segments of the fourth digit comprise the left and right blinking indicators 44A and 44B, which are synchronized with the activation of the first and second vibrating elements 20A and 20B respectively. Operating controls 52 consist of a vibration-duration control 54 and a pause-duration control 56 (FIG. 4).

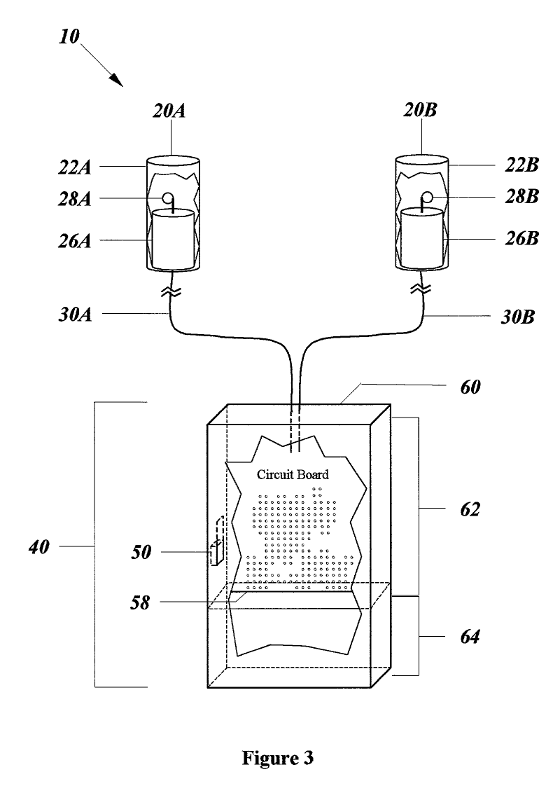

FIG. 3 shows a cutaway view of the first and second vibrating elements 20A and 20B. The first vibrating element 20A is comprised of a first enclosure 22 A made of plastic or metal, preferably cylindrical in shape and of a size to be easily held in a person's hand. Firmly attached within the first enclosure 22 A is a first electric motor 26A. A first off-center weight 28A is firmly attached to the shaft of the first electric motor 26A. The first electric motor 26A is connected to the controller 40 by the first electrical connection 30A. FIG. 3 illustrates that the construction or the second vibrating element 20B is identical to the construction of the first vibrating element 20A. The electrical connections 30A and 30B consist of insulated electrical wire having two conductors each. The preferred length of the electrical connections 30A and 30B is approximately two meters to allow for a comfortable distance between operator and subject 12.

FIG. 3 also shows a cutaway view of the back of the controller 40. A controller enclosure 60 is preferably constructed of a rigid material such as wood, plastic or metal, and is preferably of a size to be conveniently held in one or both hands. The controller enclosure 60 has two compartments, an electronics compartment 62, and a battery compartment 64. The electronics compartment houses a circuit board 58. The power switch 50 on the controller 40 is connected to a power source 70 (FIG. 4), preferably batteries contained in the battery compartment 54.

Referring now to FIGS. 1 and 4, the subject 12 can be seen placed in contact with the first and second vibrating elements 20A and 20B (FIG. 1), for example, by holding one in each hand. Other forms of bodily contact are also acceptable as long as they occur on opposite sides of the body, for example, against each thigh or against each forearm. The person controlling the device 10, usually a psychotherapist, activates device 10 by turning on power switch 50.

FIG. 4 illustrates the operation of the invention by way of an electrical block diagram. When the power switch 50 is closed, power travels to the controller 40 and activates the programmable micro-controller 100 (FIG. 4). The controller 40 directs the first and second vibrating elements 20A and 20B to begin vibrating, starting with the first vibrating element 20A and then the second vibrating element 20B, and so forth, in an alternating fashion. When the first vibrating element 20A is activated, the left blinking indicator 44A illuminates, and when the second vibrating element 20B is activated, the right blinking indicator 44B illuminates. The activation of the first vibrating element 20A, followed by a pause, and the activation of the second vibrating element 20B, followed by a pause, constitutes an “activation cycle.” During operation, the digital counter display 48 shows an updated count of activation cycles, up to a maximum of 999. Every time the power switch 50 is turned on the counting begins at 0. Once the digital counter display 48 reaches 999 it resets to 0 and begins counting again. By operating the vibration-duration control 54 the psychotherapist can increase or decrease the duration of the vibrations during an activation cycle, with the duration ranging from 5 to 300 milliseconds, but more preferably 50 to 200 milliseconds. This essentially controls the intensity of the tactile stimulation which is simply a function of how long the first and second vibrating elements 20A and 20B are activated. By operating the pause-duration control 56, the operator can increase or decrease the amount of time between the end of one vibration and the start of the next, with the pause length ranging from about 50 to 4000 milliseconds, but more preferably 100 to 2000 milliseconds. This essentially controls the cycling frequency, since shorter pauses means more rapid cycling than longer pauses. Table 1 defines an exemplary control logic sequence programmed into the programmable micro-controller 100:

TABLE 1

Start:

Initialize Counter to Zero
Turn Off Visual Display
Turn Off Motors

Cycle:

Read Resistance Value of Vibration-duration Control and store in

Vibration_Value

Read Resistance Value of Pause-duration Control and store in Pause_Value
Activate First Motor and Left Light for Vibration_Value X milliseconds
Pause for Pause_Value X milliseconds
Activate Second Motor and Right Light for Vibration_Value X milliseconds
Pause for Pause_Value X milliseconds
Increment Counter
Display Count
Goto Cycle

When in use, the operator, either psychotherapist or patient, will: (a) see that the first and second vibrating elements 20A and 20B are in contact with the patient's body 12 bilaterally, (b) turn on the power switch 50, (c) adjust the operating controls 52 to suit individual patient preference, (d) monitor the visual display module 42 as needed, and (e) adjust the operating controls 52 as needed throughout the operating period.

Accordingly, it can be seen that the device for inducing alternating tactile stimulations is simple and easy to use and is preferable to the alternatives. This device offers several advantages:

(a) The psychotherapist using this device and method can sit in a comfortable and relaxed posture instead of holding, for extended periods, the awkward postures necessary for manually tapping on patients.

(b) With this device and method the psychotherapist can induce alternating tactile stimulations with patients who might otherwise feel threatened by the psychotherapist's touch.

(c) With this device and method the psychotherapist can induce alternating tactile stimulations in the patient at a safe and comfortable distance because the two vibrating elements are attached to the control box by long wires. This is important for patients who might otherwise feel threatened by the psychotherapist's close proximity (as required for manual tapping).

(d) With this device and method the psychotherapist can induce alternating bilateral tactile stimulations in a non-intimate, non-personal way. Therefore, patients will be unlikely to perceive this tactile stimulation as a sexual overture.

(d) The psychotherapist can take notes throughout the session, since his/her hands will not be occupied with tapping on the patient.

(f) The psychotherapist and/or patient can adjust the device's duration and pause controls to suit the individual preferences of the patient.

(g) The first and second vibrating elements are sized and shaped for convenient application to a number of bilateral points on the patient's body. For example, they can be easily held in the hands, slipped under wristbands, inserted into socks or shoes, or placed under thighs. Therefore, placement of the vibrating elements can be easily suited to the individual needs and preferences of the patient.

(h) During operation the device counts and displays the number of induced alternating tactile stimulations, so a psychotherapist using this device can focus entirely on listening to and watching the patient. No additional attention would be needed for counting.

(i) This device and method can be easily used by patients for self-care. It allows the patient to experience alternating bilateral tactile stimulation passively, and on demand, so the benefits of this stimulation can be achieved while working, driving, reading, meditating, or sleeping. Without this invention patients would need to stimulate themselves by an activity such as alternate bilateral tapping, walking, or running.

While the foregoing embodiments are at present considered to be preferred, it is understood that numerous variations and modifications may be made therein by those skilled in the art. For example, the size and shape of the vibrating elements may be altered to conform to the contours of the hands or other parts of a subject's body. In the case of their use by children, the vibrating elements may be embedded in an appealing toy or stuffed animal. In addition, fastening straps may be used to attach the vibrating elements to the subject's limbs or torso. There are alternatives to electric motors with off-center weights for inducing vibrations. Some of these include, but are not limited to, electromagnetic vibrators, and acoustic elements (such as speakers operated at low frequencies). Other embodiments for the controller might consist of various combinations of keypads and visual displays such as membrane switches, joysticks, dials, meters, liquid crystal displays, and computer interfaces. Additionally, the activation of the vibrating elements may be accomplished by mechanisms other than electrical wires, such as a remote control mechanism employing radio, infrared, or ultrasonic communication.

Thus the scope of the invention should be determined by the appended claims and their equivalents, rather than by the examples given.

What is claimed is:

1. A method for treating a patient for psychiatric and physiologic symptoms by enhancing the information processing capabilities of the patient's brain comprising the steps of
(a) positioning two or more tactile stimulators on two or more areas of the patient's body bilaterally;
(b) inducing a bilateral stimulation to the patient by energizing the one or more tactile stimulators in an alternating fashion; and
(c) repeating step (b) for a therapeutically effective number of repetitions.

2. The method of claim 1 wherein the tactile stimulation devices are adapted to be held in the patient's hands.

3. A method for treating a patient for psychiatric and physiologic symptoms by enhancing the information processing capabilities of the patient's brain comprising the steps of
(a) positioning a first tactile stimulator on a first area of the patient's body;
(b) positioning a second tactile stimulator on a second area of the patient's body;
(c) energizing the first tactile stimulator;
(d) de-energizing the first tactile stimulator;
(e) energizing the second tactile stimulator;
(f) de-energizing the second tactile stimulator; and
(g) repeating steps (c)-(f) a therapeutically effective number of repetitions.

4. The method of claim 3 wherein the first area of the body is on the right side of the body.

5. The method of claim 3 wherein the second area of the body is on the left side of the body.

6. The method of claim 3 wherein the patient is suffering from post-traumatic stress disorder.

7. The method of claim 3 wherein the patient is suffering from clinical depression.

8. The method of claim 3 wherein the patient is suffering from an addictive disorder.

9. The method of claim 3 wherein the patient is suffering an eating disorder.

10. The method of claim 3 wherein the patient is suffering an obsessive/compulsive disorder.

11. The method of claim 3 wherein the patient is suffering from a dissociative disorder.

12. The method of claim 3 wherein the patient is suffering from a sexual dysfunction.

13. The method of claim 3 wherein the patient is suffering from anxiety.

14. The method of claim 3 wherein the patient is suffering from a panic disorder.

15. The method of claim 3 wherein the patient is suffering from learning disabilities.

16. The method of claim 3 wherein the patient is suffering from attention deficit disorder.

17. The method of claim 3 wherein the patient is suffering from a sleep disorder.

18. The method of claim 3 wherein the patient is suffering from pain.

19. The method of claim 3 wherein the patient's physical healing capability is enhanced.

20. The method of claim 3 wherein the patient's readiness for surgery is enhanced.

21. The method of claim 3 wherein the patient's recovery from surgery is enhanced.
